(19) United States
(12) Patent Application Publication
(10) Pub. No.: US 2008/0053230 A1
(43) Pub. Date: Mar. 6, 2008

(54) Ultrasonic Inspection Method and Ultrasonic Inspection Device

(76) Inventors: Hiroaki Katsura, Nara (JP); Yoichiro Ueda, Osaka (JP); Kazuya Ushirokawa, Osaka (JP)

Correspondence Address: STEPTOE & JOHNSON LLP, 1330 CONNECTICUT AVE., NW, WASHINGTON, DC, 20036, US

(21) Appl. No.: 11/794,429

(22) PCT Filed: Jan. 11, 2006
(86) PCT No.: PCT/JP2006/300209

§ 371 Date: Jun. 27, 2007

(30) Foreign Application Priority Data
Jan. 14, 2005 (JP) 2005-006956

(51) Int. Cl. G01N 29/28

(52) U.S. Cl. 73/571

(57) ABSTRACT

A bottom surface of a medium tank 1 is closed with a polymer film 2, the polymer film 2 is stuck to the medium tank 1 by reducing the pressure of the inside of the medium tank 1, an ultrasonic wave transmission medium 5 is injected while reducing the pressure of the inside of the medium tank 1 so that the distal end of an ultrasonic probe 3 is immersed, the inside of the medium tank 1 is pressurized while keeping an inspection object 6 in contact with the polymer film 2, an ultrasonic wave reflected by the inspection object is received by the ultrasonic probe 3.

### TECHNICAL FIELD

The present invention relates to an ultrasonic inspection method which inspects an inspection object such as an electronic component in a dry state.

### BACKGROUND ART

As means to realize a small-sized and thin product, that has been a trend in these days, a mounting area is required to be reduced, thus the number of electronic components having a rear surface electrode such as BGA and CSP has been increased. When the electronic component having a rear surface electrode is used, the joined portion thereof can not be inspected by means of optical means. Accordingly, another means is required to assure the quality.

Conventionally, there are a known method of using X-rays and ultrasonic inspection method as a method of observing the inside of the electronic component. The method of using X-rays has a great effect on inspections for disconnection, short and abnormal volume. However, the method is not suitable for an inspection for the joined portion such as separation. Since an ultrasonic wave is reflected by a portion having a different acoustical property, the ultrasonic inspection method is suitable for the inspection for the joined portion such as separation. In the ultrasonic inspection method, an inspection object is immersed in a solution as an ultrasonic wave transmission medium, and inspected by transmitting/receiving the ultrasonic wave to/from the inspection object via the solution. However, since the inspection object is immersed in the solution, the electrode materials of the inspection object are eluted as ions in the solution, and thus the reliability is lowered. In addition, since the inspection object is immersed in the solution, the ultrasonic inspection method can not be performed at a production site.

In (Patent Document 1) and (Patent Document 2), there are disclosed dry-type ultrasonic inspection methods which inspect the inspection objects without immersing the inspection objects in the solution.

Patent Document 1: JP-A-2003-177117

Patent Document 2: JP-A-11-304771

### DISCLOSURE OF THE INVENTION

### Problems to be Resolved by the Invention

In a dry-type ultrasonic inspection method described in (Patent Document 1), a container of which the bottom surface is closed with a polymer film and which stores an ultrasonic wave transmission medium therein is used, the polymer film is pressed against an inspection object, and an ultrasonic wave transmitted to the inspection object via the ultrasonic wave transmission medium and the polymer sheet is received for the inspection. Accordingly, the method is suitable for inspections for all parts in a production process as compared with that of (Patent Document 1). However, in order to repeat the inspection in the production process, the polymer film is required to be exchanged, and it is difficult to automatically attach/remove the polymer film to/from the container.

In (Patent Document 1), in order to improve the adhesion between the polymer sheet and the inspection object, a process of discharging air between the polymer sheet and the inspection object is required, and the inspection object requires a space for pressing an air-tight sealing member between the inspection object and the surroundings thereof. Accordingly, the process can not be performed on a substrate having a high mounting density under the present circumstances.

In (Patent Document 2), there is disclosed an inspection method for a tube. However, the method can not be applied to an inspection object such as an electronic component of a mounting substrate, which requires a detailed inspection.

An object of the invention is to provide an ultrasonic inspection device suitable for the inspection object such as an electronic component of a mounting substrate, which requires the detailed inspection.

### Means for Solving the Problem

According to a first aspect of the invention, there is provided an ultrasonic inspection device comprising: a medium tank of which the bottom surface is closed with a polymer film and which is hermetically sealed with an ultrasonic wave transmission medium stored therein; and an ultrasonic probe of which at least the distal end is immersed in the ultrasonic wave transmission medium stored in the medium tank, wherein the polymer film is stuck to the bottom of the medium tank, an inspection object and the medium tank are relatively moved to bring the inspection object into contact with the polymer film, and a distance between the ultrasonic probe and the inspection object is set for inspections so that an ultrasonic wave transmitted from the ultrasonic probe and reflected by the inspection object is received by the ultrasonic probe.

According to a second aspect of the invention, there is provided the ultrasonic inspection device according to the first aspect, wherein a plurality of the ultrasonic probes are provided, and the plurality of ultrasonic probes are exchangeable.

According to a third aspect of the invention, there is provided an ultrasonic inspection device comprising: a medium tank of which the bottom surface is closed with a polymer film and which is hermetically sealed with an ultrasonic wave transmission medium stored therein; and an ultrasonic probe of which at least the distal end is immersed in the ultrasonic wave transmission medium stored in the medium tank, wherein an opening formed an end face on in the bottom surface side is provided in the medium tank, the polymer film is stuck and held by reducing the pressure in the opening, an inspection object and the medium tank are relatively moved to bring the inspection object into contact with the polymer film, and an ultrasonic wave transmitted from the ultrasonic probe and reflected by the inspection object is received by the ultrasonic probe for inspections.

According to a fourth aspect of the invention, there is provided an ultrasonic inspection device comprising: a medium tank of which the bottom surface is closed with a polymer film and which is hermetically sealed with an ultrasonic wave transmission medium stored therein; and an ultrasonic probe of which at least the distal end is immersed in the ultrasonic wave transmission medium stored in the medium tank, wherein the distal end of the medium tank is narrower than the base end of the medium tank, the distal end is covered by the polymer film to close the distal end opening of the medium tank, an inspection object and the medium tank are relatively moved to bring the inspection object into contact with the polymer film, and an ultrasonic wave transmitted from the ultrasonic probe and reflected by the inspection object is received by the ultrasonic probe for inspections.

According to a fifth aspect of the invention, there is provided an ultrasonic inspection method comprising: sealing a medium tank by closing the bottom surface opening thereof with a polymer film; sticking the polymer film to the bottom of the medium tank; injecting an ultrasonic wave transmission medium so as to immerse at least the distal end of an ultrasonic probe while reducing the pressure of the inside of the medium tank; bringing an inspection object into contact with the polymer film by relatively moving the inspection object and the medium tank; and setting a distance between the ultrasonic probe and the inspection object for inspections so as to allow the ultrasonic probe to receive an ultrasonic wave transmitted from the ultrasonic probe and reflected by the inspection object.

According to a sixth aspect of the invention, there is provided an ultrasonic inspection method comprising: sealing a medium tank by closing the bottom surface opening thereof with a polymer film; sticking the polymer film to the medium tank by reducing the pressure in the opening formed in an end face on the bottom surface side; injecting an ultrasonic wave transmission medium so as to immerse at least the distal end of an ultrasonic probe; bringing an inspection object into contact with the polymer film by relatively moving the inspection object and the medium tank; and allowing the ultrasonic probe to receive an ultrasonic wave transmitted from the ultrasonic probe and reflected by the inspection object for inspections.

According to a seventh aspect of the invention, there is provided an ultrasonic inspection method comprising: sealing a medium tank by closing the bottom surface opening thereof with a polymer film; sticking the polymer film to the bottom of the medium tank by reducing the pressure of the inside of the medium tank; injecting an ultrasonic wave transmission medium so as to immerse at least the distal end of an ultrasonic probe while reducing the pressure of the inside of the medium tank; pressurizing the inside of the medium tank further in a state where an inspection object comes into contact with the polymer film by relatively moving the inspection object and the medium tank; and allowing the ultrasonic probe to receive an ultrasonic wave transmitted from the ultrasonic probe and reflected by the inspection object for inspections.

According to an eighth aspect of the invention, there is provided an ultrasonic inspection method comprising: sealing a medium tank by closing the bottom surface opening thereof with a polymer film; sticking the polymer film to the medium tank by reducing the pressure in the opening formed in an end face on the bottom surface side; injecting an ultrasonic wave transmission medium so as to immerse at least the distal end of an ultrasonic probe; pressurizing the inside of the medium tank further in a state where an inspection object comes into contact with the polymer film by relatively moving the inspection object and the medium tank; and allowing the ultrasonic probe to receive an ultrasonic wave transmitted from the ultrasonic probe and reflected by the inspection object for inspections.

According to a ninth aspect of the invention, there is provided an ultrasonic inspection method comprising: sealing a medium tank by closing the bottom surface opening thereof with a polymer film; sticking the polymer film to the bottom of the medium tank by reducing the pressure of the inside of the medium tank; injecting an ultrasonic wave transmission medium so as to immerse at least the distal end of an ultrasonic probe while reducing the pressure of the inside of the medium tank; wetting the polymer film with alcohol before or after the injection of the ultrasonic wave transmission medium into the medium tank; pressurizing the inside of the medium tank further in a state where an inspection object comes into contact with the polymer film by relatively moving the inspection object and the medium tank; and allowing the ultrasonic probe to receive an ultrasonic wave transmitted from the ultrasonic probe and reflected by the inspection object for inspections.

According to a tenth aspect of the invention, there is provided an ultrasonic inspection method comprising: sealing a medium tank by closing the bottom surface opening thereof with a polymer film; sticking the polymer film to the medium tank by reducing the pressure in an opening formed in an end face on the bottom surface side; injecting an ultrasonic wave transmission medium so as to immerse at least the distal end of an ultrasonic probe; wetting the polymer film with alcohol before or after the injection of the ultrasonic wave transmission medium into the medium tank; pressurizing the inside of the medium tank further in a state where an inspection object comes into contact with the polymer film by relatively moving the inspection object and the medium tank; and allowing the ultrasonic probe to receive an ultrasonic wave transmitted from the ultrasonic probe and reflected by the inspection object for inspections.

According to an eleventh aspect of the invention, there is provided an ultrasonic inspection method comprising: sealing a medium tank by closing the bottom surface opening thereof with a polymer film; sticking the polymer film to the bottom of the medium tank by reducing the pressure of the inside of the medium tank; injecting an ultrasonic wave transmission medium so as to immerse at least the distal end of an ultrasonic probe while reducing the pressure of the inside of the medium tank; pressurizing the inside of the medium tank further in a state where an inspection object of which the surface is wet with alcohol comes into contact with the polymer film by relatively moving the inspection object and the medium tank; and allowing the ultrasonic probe to receive an ultrasonic wave transmitted from the ultrasonic probe and reflected by the inspection object for inspections.

According to a twelfth aspect of the invention, there is provided an ultrasonic inspection method comprising: sealing a medium tank by closing the bottom surface opening thereof with a polymer film; sticking the polymer film to the medium tank by reducing the pressure in the opening formed in an end face on the bottom surface side; injecting an ultrasonic wave transmission medium so as to immerse at least the distal end of an ultrasonic probe; pressurizing the inside of the medium tank further in a state where an inspection object of which the surface is wet with alcohol comes into contact with the polymer film by relatively moving the inspection object and the medium tank; and allowing the ultrasonic probe to receive an ultrasonic wave transmitted from the ultrasonic probe and reflected by the inspection object for inspections.

### EFFECT OF THE INVENTION

In an ultrasonic inspection device and an ultrasonic inspection method according to the invention, an inspect object such as an electronic component of a mounting substrate, which requires a detailed inspection, can be inspected in a dry state, and it is possible to realize an ultrasonic inspection suitable to be performed in production sites.

### BRIEF DESCRIPTION OF THE DRAWINGS

FIG. 1 is a diagram illustrating the inspection process of an ultrasonic inspection method according to (a first embodiment) of the invention.

FIG. 2 is a diagram illustrating a process of removing a damaged polymer film in the first embodiment of the invention.

FIG. 3 is a diagram illustrating a process of attaching the polymer film in the first embodiment of the invention.

FIG. 4 is a diagram illustrating a process of cutting out the polymer film in the first embodiment of the invention.

FIG. 5 is a diagram illustrating the inspection process of an ultrasonic inspection method according to (a second embodiment) of the invention.

FIG. 6 is a diagram illustrating the inspection process of an ultrasonic inspection method according to (a third embodiment) of the invention.

FIG. 7 is a diagram illustrating the inspection process of an ultrasonic inspection method according to (a fourth embodiment) of the invention.

FIG. 8 is a diagram illustrating the inspection process of an ultrasonic inspection method according to (a fifth embodiment) of the invention.

FIG. 9 is a diagram illustrating the inspection process of an ultrasonic inspection method according to (a sixth embodiment) of the invention.

FIG. 10 is a diagram illustrating the inspection process of an ultrasonic inspection method according to (a seventh embodiment) of the invention.

FIG. 11 is a diagram illustrating the inspection process of an ultrasonic inspection method according to (an eighth embodiment) of the invention.

### BEST MODE FOR CARRYING OUT THE INVENTION

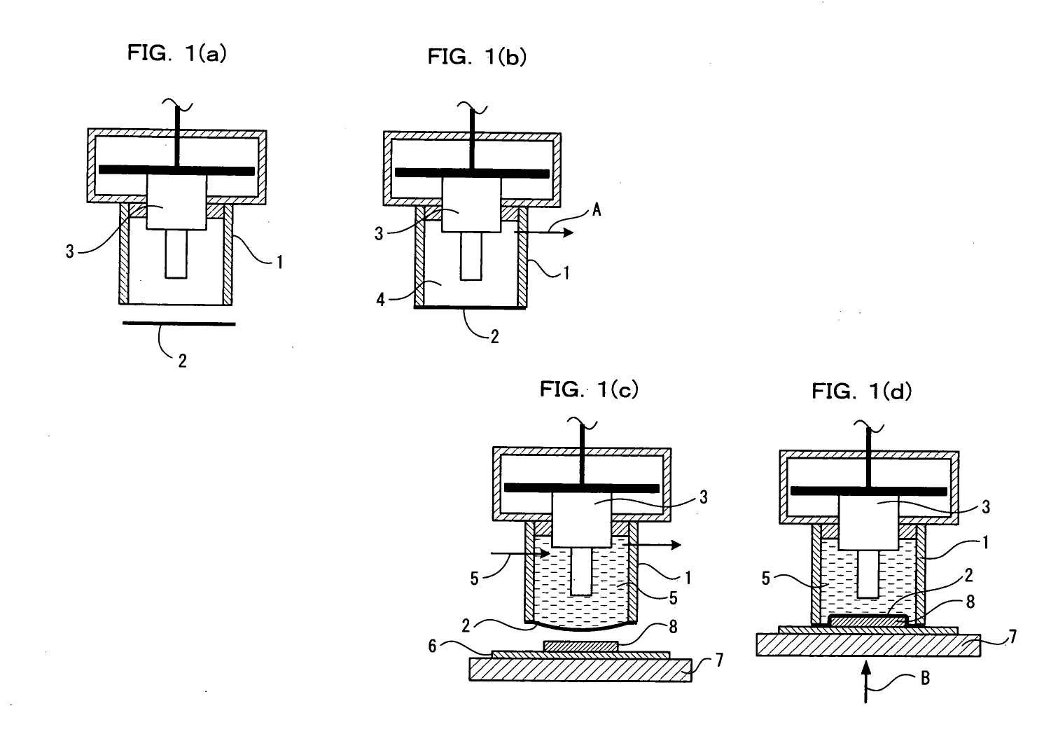

Hereinbelow, an ultrasonic inspection method according to the invention will be described on the basis of embodiments shown in FIGS. 1 to 11.

### First Embodiment

FIGS. 1 to 4 illustrate (a first embodiment) of the invention.

FIGS. 1(a) to 1(d) illustrate an ultrasonic inspection process.

As shown in FIG. 1(a), an ultrasonic inspection device includes a medium tank 1 having an opened bottom surface, a polymer film 2 closing the bottom surface of the medium tank 1, and an ultrasonic probe 3 which is movably disposed in the medium tank 1 to transmit/receive an ultrasonic wave. As the polymer film 2, it is possible to use silicon rubbers, polyvinyl chloride, polyvinylidene chloride, polyethylene, polypropylene, or the like. The film thickness thereof is in the range of several μm to several tens μm.

When the polymer film 2 is attached to the medium tank 1, the polymer film 2 is pressed against the bottom surface of the medium tank 1 as shown in FIG. 1(b), and the inside 4 of the medium tank 1 is connected to a vacuum device (not shown) and is depressurized (A) to hold the polymer film 2.

Subsequently, while continuously depressurizing (A) the inside 4 of the medium tank 1, water 5 as an ultrasonic wave transmission medium is injected into the inside 4 of the medium tank 1 as shown in FIG. 1(c). This injection amount is an amount to immerse the distal end which is an ultrasonic wave transmitting/receiving unit of the ultrasonic probe 3.

When the water 5 is injected in this manner, the center of the polymer film 2 is swollen downward because of the weight of the water 5. In this state, a stage 7 on which an inspection target substrate 6 is placed is lifted in a direction indicated by the arrow B as shown in FIGS. 1(c) and 1(d) to cover around the inspection portion 8 of the substrate 6 by the bottom of the medium tank 1. In the medium tank 1 pressed against the substrate 6 with the polymer film 2 interposed therebetween, the polymer film 2 is elastically deformed along the inspection portion 8 of the substrate 6.

In this state, a distance between the ultrasonic probe and the inspection object is adjusted and set so as to allow the ultrasonic probe to receive the ultrasonic wave transmitted from the ultrasonic probe 3 and reflected by the target-depth portion of the inspection portion 8 of the substrate 6, the ultrasonic wave is emitted, the ultrasonic wave reflected by the inspection portion 8 of the substrate 6 is received by the ultrasonic probe 3, and then a consistency in the target portion of the inspection portion 8 is inspected on the basis of a time interval between the transmission and the reception.

As described above, since the polymer film 2 is stuck and held to the medium tank 1 by the depressurization (A), the polymer film 2 is elastically deformed along the inspection portion 8 of the substrate 1 by pressing the substrate 6 against the bottom of the medium tank 1 with the polymer film 2 interposed therebetween as shown in FIG. 1(d). Accordingly, the polymer film 2 closely adheres to the inspection portion 8 with no space, the ultrasonic vibration emitted from the distal end of the ultrasonic probe 3 accurately reaches the target-depth portion of the inspection portion 8 via the water 5 and the polymer film 2, and then is accurately received by the ultrasonic probe 3 via the polymer film 2 and the water 5.

Accordingly, a process of discharging air between the polymer sheet and the inspection object is not required and the inspection object is also not required to have a space for pressing an air-tight sealing member between the inspection object and the surroundings thereof in order to improve the adhesion between the polymer sheet and the inspection object as shown in (Patent Document 1), thus the above-described process is suitable for the inspection for an in-line substrate having a high mounting density.

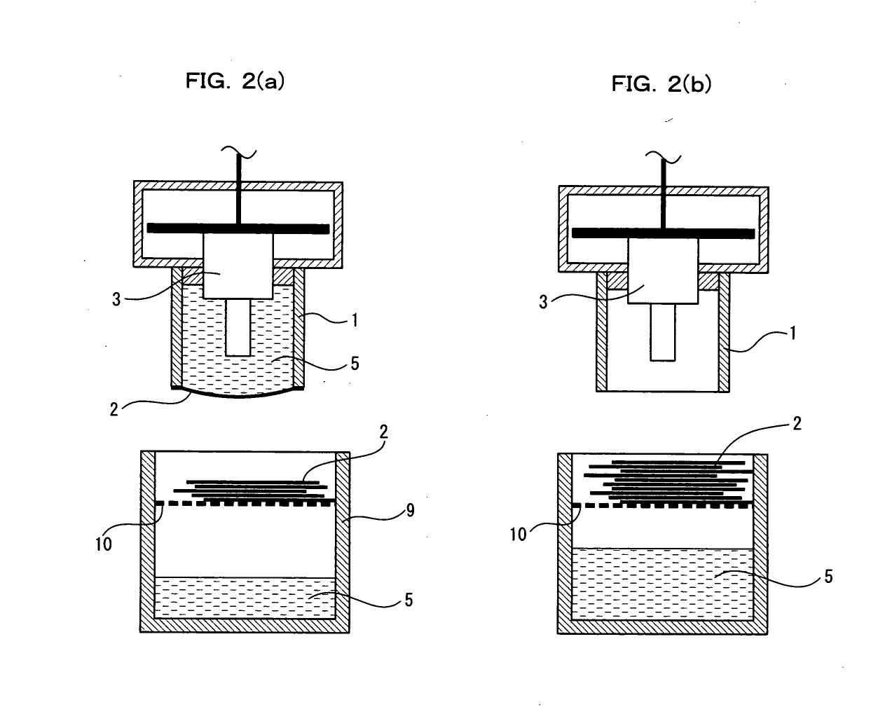

The polymer film 2 is damaged by repetitions of the inspection, and thus the accuracy of the inspection result is considered to be lowered. In this case, when the depressurization (A) is removed in a state where the polymer film 2 is moved over a waste container 9 as shown in FIG. 2(a), the used polymer film 2 is separated from the bottom of the medium tank 1 by the weight of the water 5, and falls into the waste container 9 with the injected water 5 as shown in FIG. 2(b). The inside of the waste container 9 is vertically partitioned by a net 10, and the water 5 passes through the net 10 and is collected in the bottom of the waste container 9. The used polymer film 2 selectively remains on the net 10.

Since the used polymer film 2 is not incorporated in the water 5 collected in the waste container 9, it is possible to draw and use the water 5 to be re-injected into the medium tank 1 in the process of FIG. 1(c).

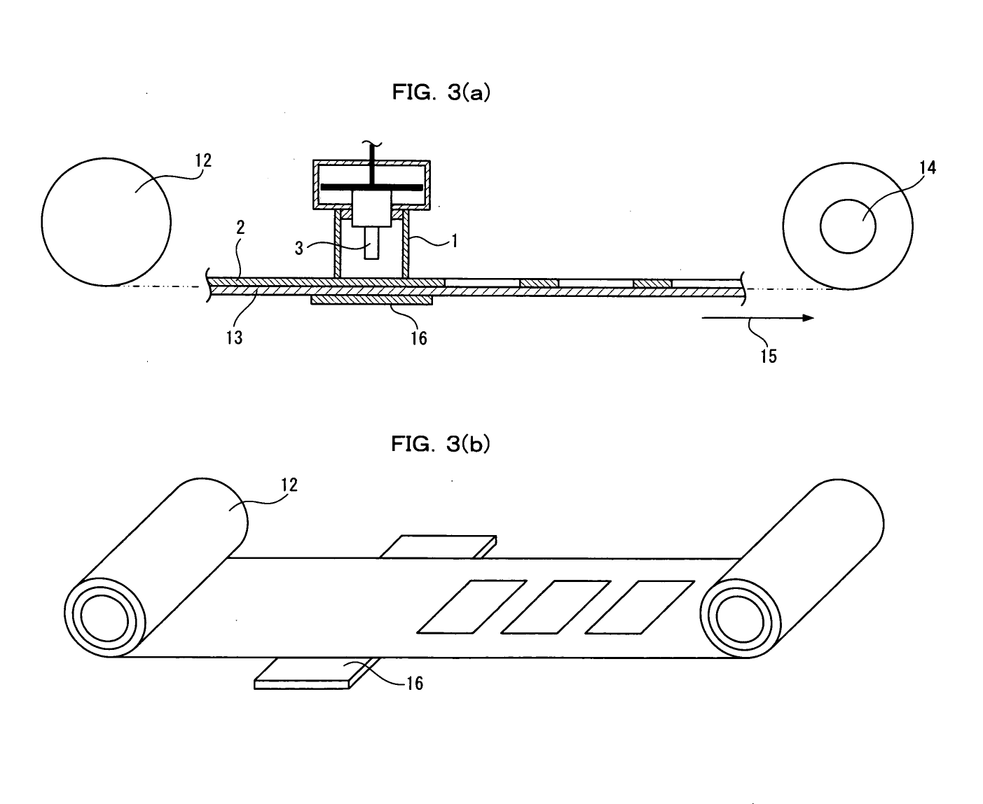

FIG. 3 illustrates the process of FIG. 1(a) in more detail.

A winding body 12 shown in FIG. 3(a) is a body in which the belt-shaped polymer film 2 backed by a board 13 is wound. The belt-shaped film from the winding body 12 is wound around a reel 14 and intermittently re-wound in a direction indicated by the arrow 15 with tension applied thereto. Reference number 16 represents a working board.

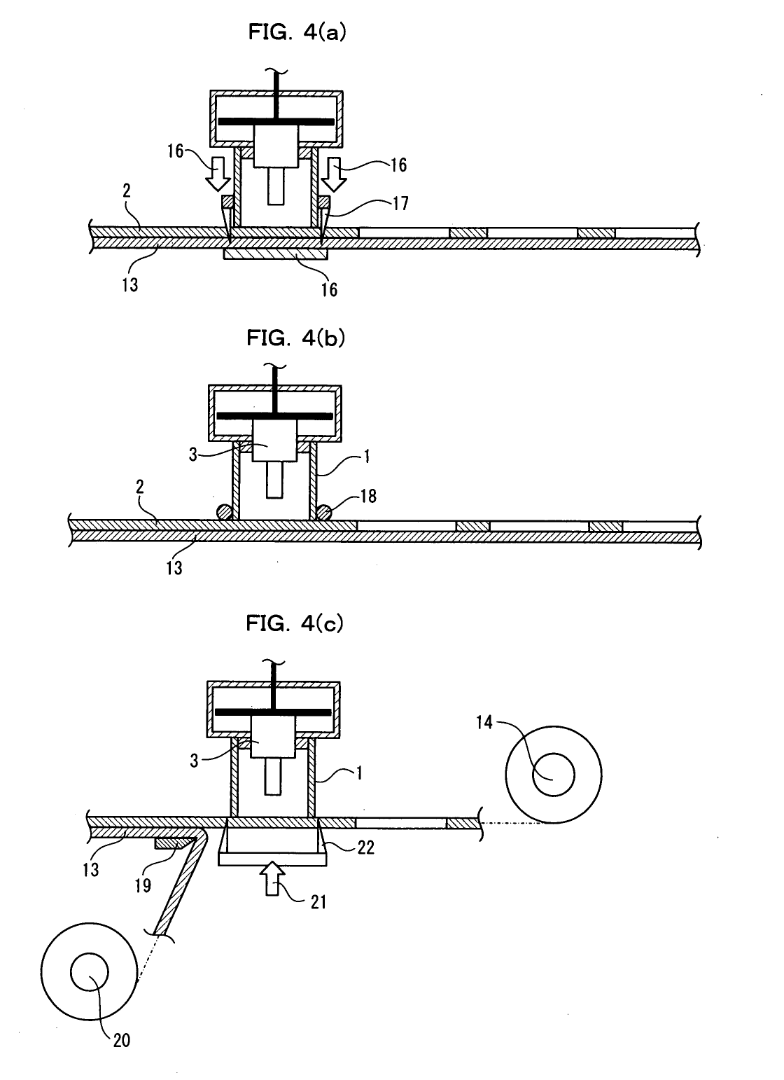

The stopped belt-shaped film with the tension applied thereto is pressed against the bottom of the medium tank 1, the medium tank 1 is depressurized (A) to stick and hold the belt-shaped film to the medium tank 1, a cutter 17 presses the working board 16 along the periphery of the medium tank 1 as shown by the arrows 16 in FIG. 4(a), then the polymer film 2 is cut out into a required shape. In this manner, the polymer film 2 is attached to the medium tank 1. FIG. 3(b) illustrates the belt-shaped film from which the polymer film 2 is cut.

As described above, the polymer film 2 is cut from the winding body 12 by means of the cutter 17 so as to be a required shape. However, as shown in FIG. 4(b), the polymer film 2 of the winding body 12 may be thermofused and cut by a heated heater 18.

As shown in FIG. 4(c), in a process ahead of the cutting, the board 13 of the winding body 12 passes through a peeling stand 19 and is wound around a rewinding reel 20 with the tension applied thereto. In synchronization with this process, only the belt-shaped polymer film 2 of the winding body 12 is wound by the reel 14 with the tension applied thereto, the bottom of the medium tank 1 is pressed against the polymer film 2 in a cutting position stopped with the tension applied thereto, the medium tank 1 is depressurized (A) to stick and hold the film to the medium tank 1, the film is pressed from lower surface side thereof by means of a cutter 22 as shown by the arrow 21, then the polymer film 2 can be cut along the periphery of the medium tank 1.

The ultrasonic probe 3 disposed in the medium tank 1 is configured to move and scan the horizontal plane on the basis of the design CAD data of the substrate 6 by an operation controlling unit, so as to automatically inspect the total inspection range of the inspection portion 8.

### Second Embodiment

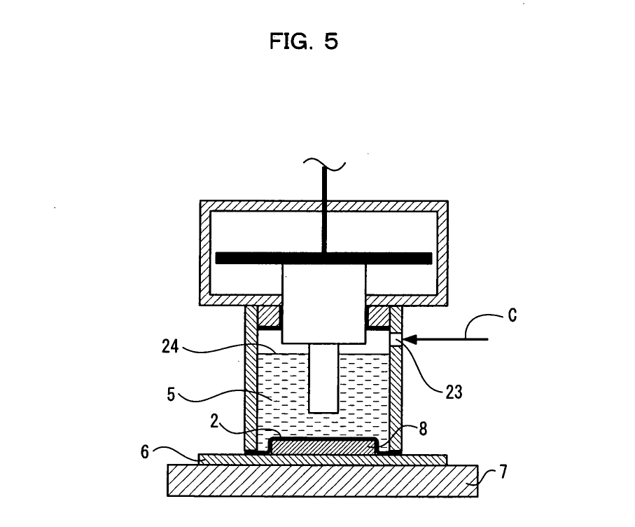

FIG. 5 illustrates (a second embodiment) of the invention.

In the ultrasonic inspection process shown in FIG. 1(d) (the first embodiment), the bottom of the medium tank 1 is pressed against the substrate 6 so that the polymer film 2 closely adheres to the inspection portion 8 of the substrate 6. However, in this (second embodiment), as shown in FIG. 1(d), the bottom of the medium tank 1 is pressed against the substrate 6, then air C is injected from a hole 23 formed in the upper portion of the medium tank 1 to further pressurize the inside 4 of the medium tank 1. Accordingly, the adhesion between the polymer film 2 and the inspection portion 8 is improved, thus the inspection accuracy is increased.

The hole 23 through which the air C is injected is preferably positioned higher than a water surface 24 of the water 5 injected into the medium tank 1 in the process of FIG. 1(c) since a bubble is not incorporated in the water 5.

### Third Embodiment

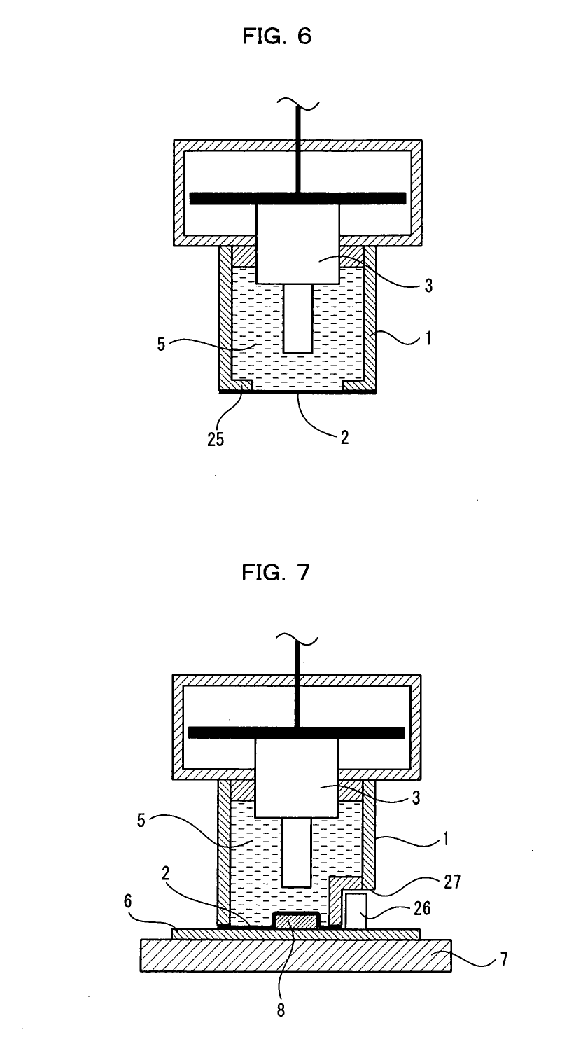

FIG. 6 illustrates (a third embodiment) of the invention.

In this embodiment, a bottom portion 25 inwardly extending from the periphery is formed in the edge of the medium tank 1 to which the polymer film 2 is held. Accordingly, it is possible to increase the contact area between the polymer film 2 and the medium tank 1, and more reliably stick and hold the polymer film 2. Only this point is different from the above-described embodiments.

### Fourth Embodiment

FIG. 7 illustrates (a fourth embodiment) of the invention.

In this embodiment, a concave portion 27 is formed in advance in the edge of the medium tank 1. Accordingly, even when a different component 26 is mounted to be adjacent to the inspection portion 8, the polymer film 2 can closely adhere to the inspection portion 8.

In such constitution, even when the mounting density of the substrate 6 is high, the substrate 6 can be inspected.

### Fifth Embodiment

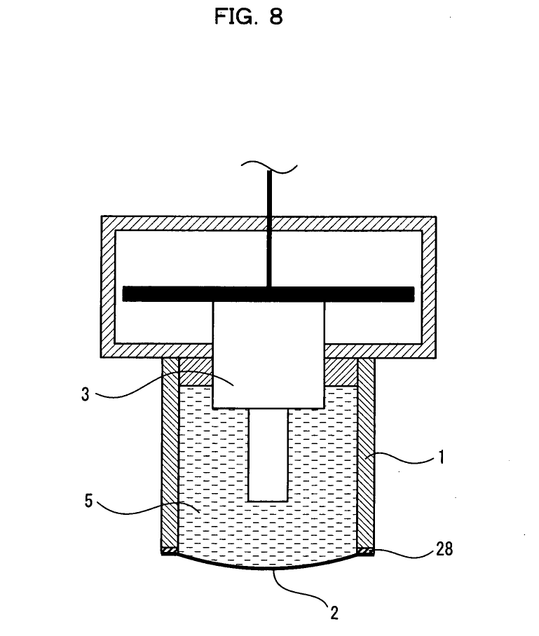

FIG. 8 illustrates (a fifth embodiment) of the invention.

The material of the edge of the medium tank 1 to which the polymer film 2 is held is not mentioned in the above-described embodiments. However, in this (fifth embodiment), an elastic body 28 having an elastic coefficient higher than that of the medium tank 1 is attached to the edge of the medium tank 1 in advance.

In such constitution, the adhesion between the medium tank 1 and the polymer film 2 increases.

### Sixth Embodiment

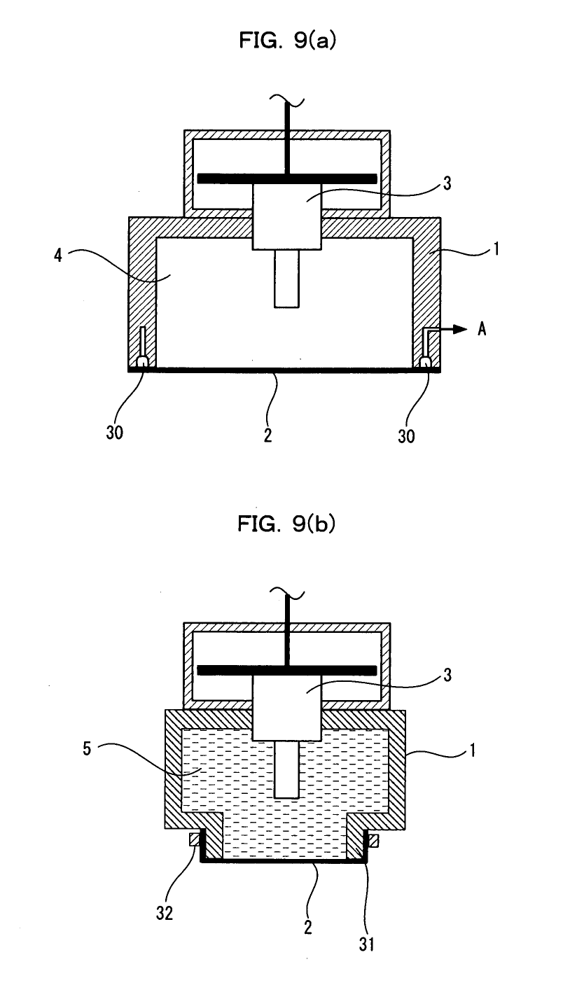

FIG. 9 illustrates (a sixth embodiment) of the invention.

In FIG. 9(a), holes 30 formed in the edge of the medium tank 1 to which the polymer film 2 is held are formed, and these holes 30 are connected to a vacuum pump (not shown) to discharge air. Accordingly, it is possible to increase the adhesion between the medium tank 1 and the polymer film 2. Since the polymer film 2 is not held by a different holder, such constitution can be compact.

Specifically, the bottom surface opening of the medium tank 1 is closed with a polymer film 2 to hermetically seal the medium tank 1, the holes 30 are depressurized (A) to stick the polymer film 2 to the bottom surface opening of the medium tank 1, the water 5 is injected so as to immerse at least the distal end of the ultrasonic probe, the inside of the medium tank 1 is pressurized further in a state where the polymer film comes into contact with the inspection portion 8, and the ultrasonic wave transmitted from the ultrasonic probe and reflected by the inspection object is received by the ultrasonic probe for the inspection.

As shown in FIG. 9(b), a distal end 31 of the medium tank 1 can be narrower than the base end of the medium tank 1, the distal end 31 can be covered by the polymer film 2, and the polymer film 2 can be fixed by a ring-shaped band 32 or the like in a position higher than the distal end 31 to close the distal end opening of the medium tank 1. By narrowing the distal end 31 of the medium tank 1 as described above, the polymer film 2 can closely adhere to the inspection portion 8, and thus the substrate 6 having a high mounting density can be inspected.

### Seventh Embodiment

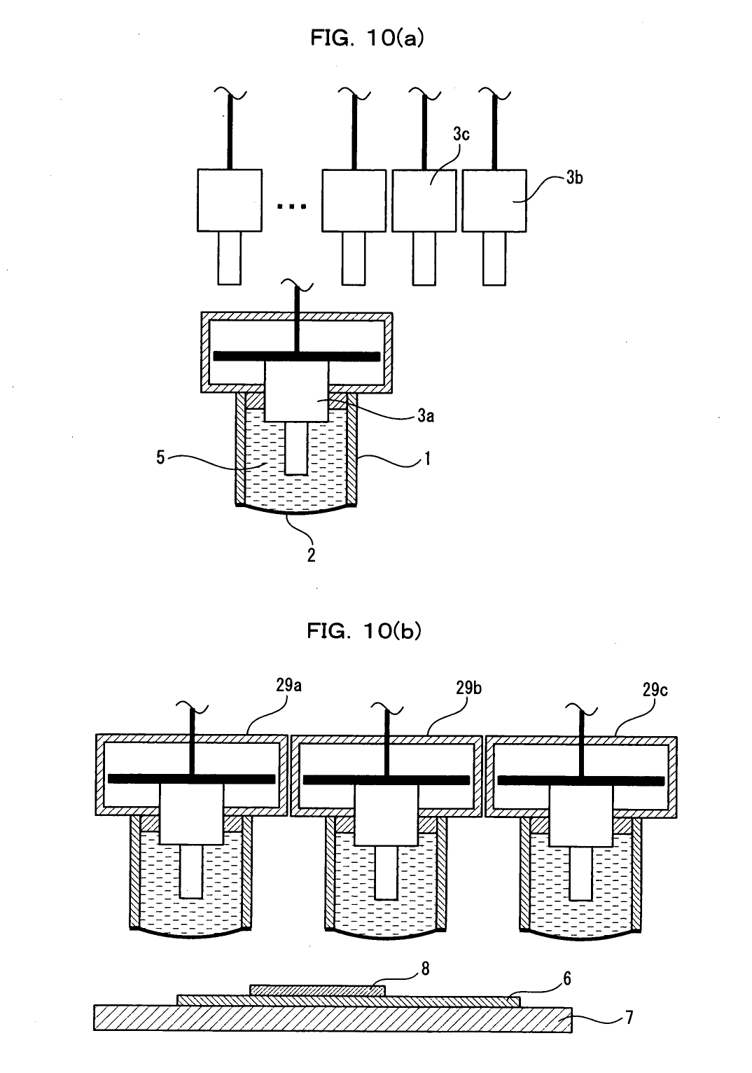

FIG. 10 illustrates (a seventh embodiment) of the invention.

In the ultrasonic inspection device shown in FIG. 10(a), a plurality of ultrasonic probes 3a, 3b, 3c . . . having transmission/reception frequencies different from one another are provided in advance, one of the ultrasonic probes 3a, 3b, 3c . . . is selected in accordance with the inspection portion and disposed in the medium tank 1, and then the inspection is performed. In such configuration, the inspection accuracy can be considered to be improved.

In the ultrasonic inspection device shown in FIG. 10(b), a plurality of ultrasonic inspection units 29a, 29b and 29c configured in accordance with the above-described embodiments or the combination thereof are provided. The transmission/reception frequencies of the plurality of ultrasonic inspection units 29a, 29b and 29c are different from one another. In the inspection process, an operation program is configured so as to perform the inspection by selecting any of the ultrasonic inspection units 29a, 29b and 29c in accordance with the inspection portion.

In such constitution, since the inspection accuracy can be improved and the process of attaching/removing the ultrasonic inspection units can be removed, the inspection efficiency can be considered to be improved.

In the above-described embodiments, the inspection target substrate 6 is moved to the ultrasonic inspection unit in which the ultrasonic probe is disposed so as to obtain the inspection state. However, the ultrasonic inspection unit in which the ultrasonic probe is disposed can be moved to the inspection target substrate 6 so as to obtain the inspection state. In this manner, since the inspection state can be obtained by moving both of the unit and the inspection target to be close to each other, in addition to the operation program for obtaining the inspection state by moving one of the inspection target and the unit to the other, the inspection object and the medium tank can be relatively moved to bring the inspection object into contact with the polymer film, and the ultrasonic wave transmitted from the ultrasonic probe and reflected by the inspection object can be received by the ultrasonic probe for the inspection.

### Eighth Embodiment

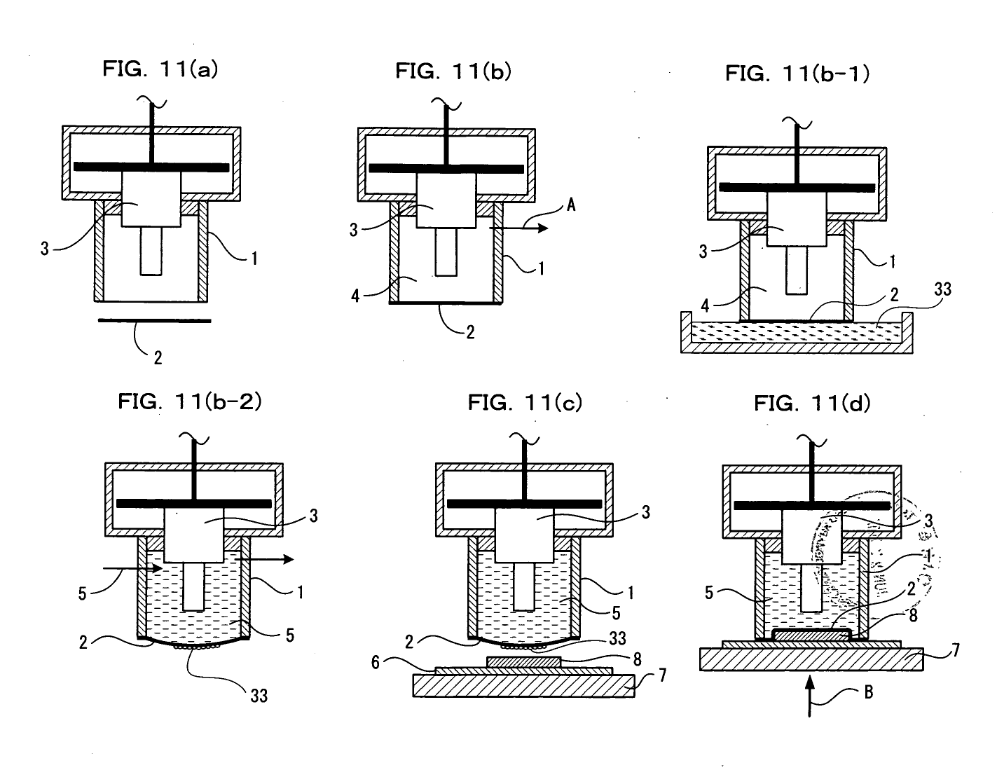

In the ultrasonic inspection method shown in FIGS. 1(a) to 1(d), the pressure of the inside 4 of the medium tank 1 is reduced as shown in FIG. 1(b), subsequently, the ultrasonic wave transmission medium is injected into the inside 4 of the medium tank 1 as shown in FIG. 1(c), and the polymer film 2 is pressed against the inspection portion 8 as shown in FIG. 1(d). However, in this (eighth embodiment), as shown in FIGS. 11(a) to 11(d), the processes of FIGS. 11(b-1) and 11(b-2) are added between the processes of FIGS. 11(b) and 11(c), and only this point is different from FIG. 1. In this embodiment, it is possible to avoid the reduction in inspection accuracy due to the uneven surface of the inspection portion 8.

Specifically, in FIG. 11(b-1), the polymer film 2 attached to the medium tank 1 is socked in alcohol 33. In FIG. 11(b-2), the water 5 as the ultrasonic wave transmission medium is injected into the medium tank 1, thus the center of the polymer film 2 is swollen downward. The alcohol 33 adhering to the polymer film 2 is collected in the center of the polymer film 2.

In this state, by lifting the stage 7 on which the inspection target substrate 6 is placed in a direction indicated by the arrow B as shown in FIGS. 11(c) to 11(d), the alcohol 33 initially collected in the center of the polymer film 2 comes into contact with the center of the upper surface of the inspection portion 8, and the unevenness (not shown) of the center of the upper surface of the inspection portion 8 is wet with the alcohol 33. Accordingly, the alcohol 33 is introduced to the concave portion of the central portion of the upper surface of the inspection portion 8. With the lifting of the stage 7, since the polymer film 2 comes into contact with the upper surface of the inspection portion 8 from the center toward the exterior, and the remaining alcohol 33 supplied to the central portion of the upper surface of the inspection portion 8 spreads toward the exterior of the inspection portion 8, the concave portion of the inspection portion 8 is filled with the alcohol 33, and the inspection portion 8 closely adheres to the polymer film 2 in a state where there is no air between the inspection portion 8 and the polymer film 2. The remaining alcohol 33 eliminated between the inspection portion 8 and the polymer film 2 vaporizes so that the alcohol 33 does not exist on the substrate 6. Accordingly, there is no effect on electrical performance.

As described above, even when the surface of the inspection portion 8 is uneven, the polymer film 2 closely adheres to the inspection portion 8 by introducing the alcohol 33 to the inspection portion 8. Accordingly, the inspection accuracy is improved as compared with a case in which the air remains in the concave portion of the surface of the inspection portion 8.

As the alcohol 33, isopropyl alcohol, ethanol and methanol can be used.

In FIGS. 11(a) to 11(d), the polymer film 2 attached to the medium tank 1 is socked in the alcohol 33 in FIG. 11(b-1), and the ultrasonic wave transmission medium is injected into the medium tank 1 in FIG. 11(b-2). However, the same effect can be obtained even when the ultrasonic wave transmission medium is injected into the medium tank 1 just after the attachment of the polymer film 2 to the medium tank 1, the polymer film 2 is soaked in the alcohol 33, and then the polymer film 2 closely adheres to the inspection portion 8 in the processes of FIGS. 11(c) and 11(d).

### Ninth Embodiment

In the (eighth embodiment) shown in FIG. 11, the polymer film 2 is wet with the alcohol in FIG. 11(b-1). However, instead of wetting the polymer film 2 with the alcohol, even when the surface of the inspection portion 8 closely adhering to the polymer film 2 is supplied with the alcohol and wet with the alcohol, the same effect as the (eighth embodiment) can be obtained.

### INDUSTRIAL APPLICABILITY

The invention can realize accurate ultrasonic inspection without wetting an inspection object in a production process. Accordingly, the invention can be used in in-line inspection for an electronic substrate mounting a variety of semiconductor devices.

1. An ultrasonic inspection device comprising:
a medium tank of which the bottom surface is closed with a polymer film and which is hermetically sealed with an ultrasonic wave transmission medium stored therein; and
an ultrasonic probe of which at least the distal end is immersed in the ultrasonic wave transmission medium stored in the medium tank,
wherein the polymer film is stuck to the bottom of the medium tank, an inspection object and the medium tank are relatively moved to bring the inspection object into contact with the polymer film, and a distance between the ultrasonic probe and the inspection object is set for inspections so that an ultrasonic wave transmitted from the ultrasonic probe and reflected by the inspection object is received by the ultrasonic probe.

2. The ultrasonic inspection device according to claim 1, wherein a plurality of the ultrasonic probes are provided, and the plurality of ultrasonic probes are exchangeable.

3. An ultrasonic inspection device comprising:
a medium tank of which the bottom surface is closed with a polymer film and which is hermetically sealed with an ultrasonic wave transmission medium stored therein; and
an ultrasonic probe of which at least the distal end is immersed in the ultrasonic wave transmission medium stored in the medium tank,
wherein an opening formed in an end face on the bottom surface side is provided in the medium tank, the polymer film is stuck and held by reducing the pressure in the opening, an inspection object and the medium tank are relatively moved to bring the inspection object into contact with the polymer film, and an ultrasonic wave transmitted from the ultrasonic probe and reflected by the inspection object is received by the ultrasonic probe for inspections.

4. An ultrasonic inspection device comprising:
a medium tank of which the bottom surface is closed with a polymer film and which is hermetically sealed with an ultrasonic wave transmission medium stored therein; and
an ultrasonic probe of which at least the distal end is immersed in the ultrasonic wave transmission medium stored in the medium tank,
wherein the distal end of the medium tank is narrower than the base end of the medium tank, the distal end is covered by the polymer film to close the distal end opening of the medium tank, an inspection object and the medium tank are relatively moved to bring the inspection object into contact with the polymer film, and an ultrasonic wave transmitted from the ultrasonic probe and reflected by the inspection object is received by the ultrasonic probe for inspections.

5. An ultrasonic inspection method comprising:
sealing a medium tank by closing the bottom surface opening thereof with a polymer film;
sticking the polymer film to the bottom of the medium tank;
injecting an ultrasonic wave transmission medium so as to immerse at least the distal end of an ultrasonic probe while reducing the pressure of the inside of the medium tank;
bringing an inspection object into contact with the polymer film by relatively moving the inspection object and the medium tank; and
setting a distance between the ultrasonic probe and the inspection object for inspections so as to allow the ultrasonic probe to receive an ultrasonic wave transmitted from the ultrasonic probe and reflected by the inspection object.

6. An ultrasonic inspection method comprising:
sealing a medium tank by closing the bottom surface opening thereof with a polymer film;
sticking the polymer film to the medium tank by reducing the pressure in the opening formed in an end face on the bottom surface side;
injecting an ultrasonic wave transmission medium so as to immerse at least the distal end of an ultrasonic probe;
bringing an inspection object into contact with the polymer film by relatively moving the inspection object and the medium tank; and
allowing the ultrasonic probe to receive an ultrasonic wave transmitted from the ultrasonic probe and reflected by the inspection object for inspections.

7. An ultrasonic inspection method comprising:
sealing a medium tank by closing the bottom surface opening thereof with a polymer film;
sticking the polymer film to the bottom of the medium tank by reducing the pressure of the inside of the medium tank;
injecting an ultrasonic wave transmission medium so as to immerse at least the distal end of an ultrasonic probe while reducing the pressure of the inside of the medium tank;
pressurizing the inside of the medium tank further in a state where an inspection object comes into contact with the polymer film by relatively moving the inspection object and the medium tank; and
allowing the ultrasonic probe to receive an ultrasonic wave transmitted from the ultrasonic probe and reflected by the inspection object for inspections.

8. An ultrasonic inspection method comprising:
sealing a medium tank by closing the bottom surface opening thereof with a polymer film;
sticking the polymer film to the medium tank by reducing the pressure in the opening formed in an end face on the bottom surface side;
injecting an ultrasonic wave transmission medium so as to immerse at least the distal end of an ultrasonic probe;
pressurizing the inside of the medium tank further in a state where an inspection object comes into contact with the polymer film by relatively moving the inspection object and the medium tank; and
allowing the ultrasonic probe to receive an ultrasonic wave transmitted from the ultrasonic probe and reflected by the inspection object for inspections.

9. An ultrasonic inspection method comprising:
sealing a medium tank by closing the bottom surface opening thereof with a polymer film;
sticking the polymer film to the bottom of the medium tank by reducing the pressure of the inside of the medium tank;
injecting an ultrasonic wave transmission medium so as to immerse at least the distal end of an ultrasonic probe while reducing the pressure of the inside of the medium tank;
wetting the polymer film with alcohol before or after the injection of the ultrasonic wave transmission medium into the medium tank;
pressurizing the inside of the medium tank further in a state where an inspection object comes into contact with the polymer film by relatively moving the inspection object and the medium tank; and
allowing the ultrasonic probe to receive an ultrasonic wave transmitted from the ultrasonic probe and reflected by the inspection object for inspections.

10. An ultrasonic inspection method comprising:
sealing a medium tank by closing the bottom surface opening thereof with a polymer film;
sticking the polymer film to the medium tank by reducing the pressure in an opening formed in an end face of the bottom surface side;
injecting an ultrasonic wave transmission medium so as to immerse at least the distal end of an ultrasonic probe;
wetting the polymer film with alcohol before or after the injection of the ultrasonic wave transmission medium into the medium tank;
pressurizing the inside of the medium tank further in a state where an inspection object comes into contact with the polymer film by relatively moving the inspection object and the medium tank; and
allowing the ultrasonic probe to receive an ultrasonic wave transmitted from the ultrasonic probe and reflected by the inspection object for inspections.

11. An ultrasonic inspection method comprising:
sealing a medium tank by closing the bottom surface opening thereof with a polymer film;
sticking the polymer film to the bottom of the medium tank by reducing the pressure of the inside of the medium tank;
injecting an ultrasonic wave transmission medium so as to immerse at least the distal end of an ultrasonic probe while reducing the pressure of the inside of the medium tank;
pressurizing the inside of the medium tank further in a state where an inspection object of which the surface is wet with alcohol comes into contact with the polymer film by relatively moving the inspection object and the medium tank; and
allowing the ultrasonic probe to receive an ultrasonic wave transmitted from the ultrasonic probe and reflected by the inspection object for inspections.

12. An ultrasonic inspection method comprising:
sealing a medium tank by closing the bottom surface opening thereof with a polymer film;
sticking the polymer film to the medium tank by reducing the pressure in the opening formed in an end face on the bottom surface side;
injecting an ultrasonic wave transmission medium so as to immerse at least the distal end of an ultrasonic probe;
pressurizing the inside of the medium tank further in a state where an inspection object of which the surface is wet with alcohol comes into contact with the polymer film by relatively moving the inspection object and the medium tank; and
allowing the ultrasonic probe to receive an ultrasonic wave transmitted from the ultrasonic probe and reflected by the inspection object for inspections.
